(19) United States
(12) Patent Application Publication
(10) Pub. No.: US 2009/0048860 A1
(43) Pub. Date: Feb. 19, 2009

(54) PROVIDING A RATING FOR DIGITAL MEDIA BASED ON REVIEWS AND CUSTOMER BEHAVIOR

(75) Inventors: Adam Bennett Brotman, Seattle, WA (US); Glen Arthur O'Connor, Renton, WA (US); Nandini Ranjitkumar, Phoenix, AZ (US); Todd Brian Guill, Bainbridge Island, WA (US); Daniel Martin Snell, Kirkland, WA (US); William G. Bronske, Lake Stevens, WA (US)

Correspondence Address: Corbis Corporation;c/o DARBY & DARBY P.C., P.O. BOX 770, Church Street Station, NEW YORK, NY, 10008-0770, US

(73) Assignee: Corbis Corporation, Seattle, WA (US)

(21) Appl. No.: 12/143,703

(22) Filed: Jun. 20, 2008

Related U.S. Application Data
(63) Continuation-in-part of application No. 11/382,204, filed on May 8, 2006.
(60) Provisional application No. 60/945,879, filed on Jun. 22, 2007.

(51) Int. Cl. G06Q 99/00

(52) U.S. Cl. 705/1

(57) ABSTRACT

Automatically determining pricing for at least one unit of content that can be selected and licensed or purchased over a network. Pricing is determined based on an initial price, and at least one of the following: a reviewer rating, content activity, or a customer offer price. Each of these factors may be weighted. The initial price may be a minimum price, a maximum price, a suggested price from a content owner, a pre-calculated market price, or other initial price. Content activity generally reflects user behaviors related to a content item, such as selecting a content item from a search results list, saving it as a favorite, returning to view it, placing it in a virtual shopping cart, or licensing it. Content activity combined with reviewer rating and/or offer price, indicates a “snappyness” score. A new price is dynamically calculated based on the initial price and snappyness score.

### CROSS REFERENCE TO RELATED APPLICATIONS

This application is a Continuation-In-Part patent application of U.S. patent application Ser. No. 11/382,204, filed on May 8, 2006 and entitled “Determining Content Pricing For Categories Of Use Based On Extrinsic And Intrinsic Factors,” claiming the benefit under 35 U.S.C. § 120 and further claims priority to U.S. Provisional Application Ser. No. 60/945,879 filed on Jun. 22, 2007, entitled “Providing A Rating For Digital Media Based On Reviews And Customer Behavior,” claiming benefit under 35 U.S.C. § 119 (e), each of which are incorporated by reference herein.

### FIELD OF ART

The present invention relates to determining a rating for assets, and more particularly, for determining a rating for assets such as digital content, where the rating is based on content provider valuation and extrinsic factors, and the rating may be used to determine price or a price adjustment for licensing or selling assets.

### BACKGROUND

Content can generally include, but is not limited to, images, pictures, videos, illustrations, drawings, graphics, symbols, text, and audio recordings. Also, content can be digitized and embodied in an electronic format that can be communicated over a network and/or included in a processor readable media. Typical customers of such content for commercial purposes include advertisers, publishers, media companies, graphic designers, editors, art directors, artists, writers, and the like. Additionally, sellers of digital content often employ several different methods for determining prices for the use of selected content. A seller generally licenses use of content (e.g., is a licensor), but may also sell all rights in content. Prices are generally licensing prices, but may be full sale prices.

One method for a seller to determine a price for content is the Rights Managed (RM) pricing model. For example, the seller determines a particular price for content selected by a customer that further provides an intended type of use, territory of use, start date, duration, industry, and type/size of an electronic format for the selected content. The RM model enables customization of a particular price for selected content for each customer, but it can also be expensive for the seller to administer and somewhat cumbersome and time consuming for customers to use.

Another method that sellers employ to determine customer pricing for content is the Royalty Free (RF) model. For example, based on the selection of a particular electronic format/size, a fixed price is determined in advance for most every popular use of the content. The RF model can be less expensive for a seller to administer than the RM model and relatively easy for customers to use. However, in some cases, the RF model can provide prices for content that may be too low for some uses and too high for other uses. Consequently, sales of content priced with the RF model may be lost because the fixed price is too expensive (too far removed) from the customer's actual use. Also, the seller may forego substantial profits on content that has become more valuable since the fixed price was predetermined (fixed price was set too low). The seller may try adjusting the price through trial an error, but it is generally difficult for the seller to obtain market data regarding individual content items and to determine an appropriate price or price adjustment.

It is also difficult to determine a rating of content relative to each other. Typically, a rating may be provided by a reviewer. Rankings of content, such as search rankings, may also be determined based on user behaviors. However, a unified rating is generally not available, such that an accurate price may not be determined.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates a system diagram of one embodiment of an environment in which the invention may be practiced;

FIG. 2 shows one embodiment of a mobile device that may be included in a system implementing the invention;

FIG. 3 illustrates one embodiment of a network device that may be included in a system implementing the invention;

FIG. 4 shows a logical flow diagram generally showing one embodiment of a process for determining prices for selected content based on one or more intrinsic and/or extrinsic value factors;

FIG. 5 illustrates a logical flow diagram of a process for customizing categories of use and/or pricing for content that is subsequently displayed for sale to one or more customers;

FIG. 6 shows a logical flow diagram for determining prices for categories of use for content in response to their selection by a customer;

FIG. 7 illustrates a logical flow diagram for determining prices for categories of use for content in advance of their selection by a customer;

FIG. 8 shows a logical flow diagram for processing value factors which can be generally applied to both intrinsic value factors and extrinsic value factors;

FIG. 9 illustrates a display of an exemplary page, which includes five images that are the result of a search on the word “jazz”;

FIG. 10 shows a display of a display of a page, which is the result of selecting the image in a search results page;

FIG. 11 illustrates a display of a page which depicts help information that explains a royalty free plus pricing model to a customer in accordance with the invention;

FIG. 12 is a simplified block diagram of an embodiment of an on-line image licensing system with dynamic price adjustment;

FIGS. 13A-13D are example screen shots of a photographer-facing interface for uploading and pricing images;

FIG. 14 is an example screen shot showing photographers' images with published prices displayed;

FIG. 15 is an example screen shot of a reviewer-facing interface for a reviewer to rate images;

FIG. 16 is an example screen shot of a customer-facing interface for browsing and licensing images;

FIGS. 17A and 17B are example screen shots of a customer-facing user interface for searching for images within an archive, by price;

FIG. 18 is a simplified flowchart of a method for dynamically setting and adjusting published prices for images, for on-line licensing of images, in accordance with an embodiment of the present invention; and

FIG. 19 is a simplified flowchart for a method for computing a snappyness score, in accordance with an embodiment of the present invention.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods, or devices. Accordingly, the present invention may take the form of an entirely hardware embodiment, an entirely software embodiment or an embodiment combining software and hardware aspects. The following detailed description is, therefore, not to be taken in a limiting sense.

Embodiments of the invention are generally directed to a method, system, apparatus, and processor readable media for automatically determining pricing for at least one unit of content that can be selected and purchased over a network. The content can be priced for one or more of a plurality of predetermined categories of use and in one or more formats. Also, one or more sources can provide intrinsic and extrinsic value factors that correspond to each unit of content. Further, one or more of these sources can be separate from an initial source or creator of the content. Additionally, one or more of these factors can be manually and/or automatically processed to subsequently determine a price for a unit of content for at least one of a plurality of predetermined categories of use. This processing can include one or more methods, including, but not limited to, normalization, arithmetic computations, functional analysis, weighting, coalescing, aggregation, and statistics.

In determining a price to offer a unit of content, different, or somewhat similar weights can be associated with one or more of the extrinsic and intrinsic value factors. An intrinsic value factor can be based on at least one of, but not limited to, the following information: cost to obtain the content from a source; source of content, author of content, date of content creation, geographic locale of content creation, negotiated price to use the content for each of the plurality of predetermined categories of use; cost to manufacture the content in each format that can be made available to a customer; cost of media to provide content; and/or cost to store the content. An intrinsic value factor may also be based on proposed price information, such as a suggested licensing price, a minimum licensing price, a maximum licensing price, a volume discount, and/or other pricing information proposed by the content creator, current content owners(s), or content provider.

Additionally, an extrinsic value factor can be based on at least one of, but not limited to, the following information: a collection of content; current and/or past sales history; content stored in shopping carts; promotions; reviews; popularity; industry; weather; season; death and/or destruction of content subject; holidays; events; anniversaries; ranking; models; production; reproducibility; designation; use; renown of the content's author; renown of the content; search result hits; and the like. In one embodiment, an extrinsic value factor is referred to herein as “snappyness,” which is generally based on reviewer ratings of content, content activity, or other factors associated with the content. Content activity is generally based on one or more user behaviors. Examples of user behaviors include: users making the content a favorite, users selecting the content from a list of search results, users downloading the content, users sending content (or links) to other users, users adding the content to a shopping cart, users proposing a new or alternate price, users licensing the content, and the like. Lack of user action may also affect content activity. For example, a long period of no user activity on a content item indicates a temporal decay in content activity, and may affect the overall “snappyness” of that content item. Snappyness may be provided to content providers, content users, administrators, or others for adjusting prices, determining a price category for content, ranking content, ranking content providers based on an aggregation of snappyness of each content from each provider, or other applications.

In one embodiment, a plurality of predetermined uses presented to each customer can be relatively the same. In another embodiment, the plurality of predetermined uses can be custom tailored to a particular customer based at least in part on a profile. In yet another embodiment, the plurality of predetermined uses can be more custom tailored to typical applications in a particular industry, events, or promotions that are associated with the customer. In still another embodiment, the customer is provided with an interface for customizing a grouping of one or more of the predetermined uses.

In one embodiment, prior to the presentation of content for selection by a customer for an unspecified use, or one of the predetermined uses, the intrinsic and/or extrinsic value factors can be preprocessed and employed to determine a price for units of the content. This preprocessing can include one or more methods, including, but not limited to, normalization, functional analysis, weighting, coalescing, aggregation, and statistics. In another embodiment, the processing of the extrinsic and intrinsic value factors can be performed in real time for each unit of content selected by the customer an unspecified use, or for one of the predetermined plurality of uses.

In a further embodiment, a third party reseller of content is provided with access to the plurality of predetermined uses and determined price for each unit of content. An interface may be provided along with access to the content that enables the reseller's customers to have relatively automatic access to the determined pricing. In a still further embodiment, access to the determined pricing is provided to the reseller through an application programming interface (API) and/or some other mechanism(s) that enables the reseller to incorporate the pricing information directly into their system for selling to customers.

In yet another embodiment, the customer may select content for an unspecified use or for one of the predetermined uses with stationary and/or mobile devices coupled to at least one of a wired or wireless network. Additionally, the invention enables content and the determined pricing for unspecified uses, or for predetermined uses, to be accessible to customers in one or more ways, including, but not limited to, a networked service such as provided by a web server and/or File Transfer Protocol (FTP) server, mobile device interface, downloadable and/or installable application, and/or a Digital Asset Management (DAM) system.

In yet a further embodiment, the predetermined categories of use for the invention can include, but are not limited to, as follows: all uses, above the line, below the line, internal, editorial, and Web (Internet) Only. Table 1, as listed below, provides further detail for one embodiment of the invention regarding each of a plurality of exemplary predetermined categories of use.

TABLE I
Predetermined Categories of Use For Royalty Free Plus

| Usage | Description |
|---|---|
| All Uses | Unlimited perpetual use for all categories |
| Above the Line | Unlimited perpetual use for advertisements |
| | and promotions, including print ads (magazine, |
| | newspaper, free standing inserts, directories), |
| | paid space Web advertisements, outdoor displays |
| | (billboards, hoardings, banners), and TV/cinema |
| | commercials. |
| Below the Line | Unlimited perpetual use for advertisements and |
| | promotions, including brochures/direct mail, |
| | sales materials, annual reports, in-store dis- |
| | plays (electronic or print), e-mail, trade show |
| | displays and corporate/promotional web sites. |
| Web Only | Unlimited perpetual use for paid space web ads, |
| | corporate/promotional web sites, and e-mails. |
| Internal | Unlimited perpetual use for distribution within |
| | a single company or organization for collateral, |
| | presentations, training, e-mail, or intranet |
| | uses. |
| Product Only | Unlimited perpetual use for product packaging, |
| | retail products, wall décor or incorporated in |
| | a TV/film/web entertainment program without |
| | promotion of a product, person, service or |
| | company. |
| Editorial (small) | Perpetual use in the context of a single edi- |
| | torial article, book (interior or cover) or |
| | broadcast whose purpose is to educate and/or |
| | convey news, information or fair comment opinion |
| | without direct promotion of a product, person, |
| | service of company. Limited to ½ page |
| | printed, ½ screen for web, or less |
| | than 5 seconds in a broadcast. |
| Editorial (large) | Perpetual use in the context of a single edi- |
| | torial article, book (interior or cover) or |
| | broadcast whose purpose is to educate and/or |
| | convey news, information or fair comment opinion |
| | without direct promotion of a product, person, |
| | service or company. Unlimited by size on a page, |
| | size on a screen, or display time in a broadcast. |

Additionally, although not shown in Table 1, a customer can aggregate particular categories of use. For aggregated categories of use, the determined pricing can be simply aggregated and/or discounted based on one more factors such as number of categories aggregated, customer profile, promotions, sales, cost, and the like. Furthermore, in some embodiments, customized categories of use may be provided based on a customer's profile, industry, promotion, and/or a particular collection of units of content.

In yet a further embodiment, the royalty managed pricing model can be modified with the invention to provide particular categories of use that are determined based on intrinsic and/or extrinsic value factors along with other categories of use that additionally require the customer to specify information such as specific use before a price is determined for selected content. For some embodiments, a listing such as Table 2 below could be displayed for selected content that employ the invention for a royalty managed plus pricing model. For this exemplary embodiment, hyper links are arranged for categories of use that require additional customer information before a price can be provided. As shown, determined prices are provided for those categories of use that can employ previously obtained value factors to determine a price (don't have to ask the customer for additional information to determine the price for selected content).

TABLE 2
Royalty-Managed Plus Content

| Usage | Price |
|---|---|
| All Uses | Specify Use (hyperlink) |
| Above the Line | Specify Use (hyperlink) |
| Below the Line | Specify Use (hyperlink) |
| Web Only | Specify Use (hyperlink) |
| Internal | $249 |
| Product Only | Specify Use (hyperlink) |
| Editorial (small) | $200 |
| Editorial (large) | $499 |

Other aspects of the present invention concern a content licensing system, such as an on-line photo licensing system, which receives content from content providers, manages them in an archive, and licenses them to customers. Generally speaking, the content licensing system provides a virtual marketplace and brokerage that includes a content-provider interface, via which a content provider uploads his content into the system; and a customer interface, via which a customer searches or browses the system's content archive and possibly licenses one or more content units.

One of the many challenges in maintaining a successful content licensing system, such as a photo licensing system, is dynamic price adjustment, to reflect market behavior and content providers' desired pricing. Efficient price adjustment may lead to significantly higher revenues for content providers, and for on-line licensing brokers. Embodiments of the present invention determine price adjustments. Price adjustments can be provided to the content providers, who may choose to manually change the current pricing of content. Alternatively, price adjustments may be automatically applied to current pricing, so that pricing is dynamically updated automatically.

### Illustrative Operating Environments

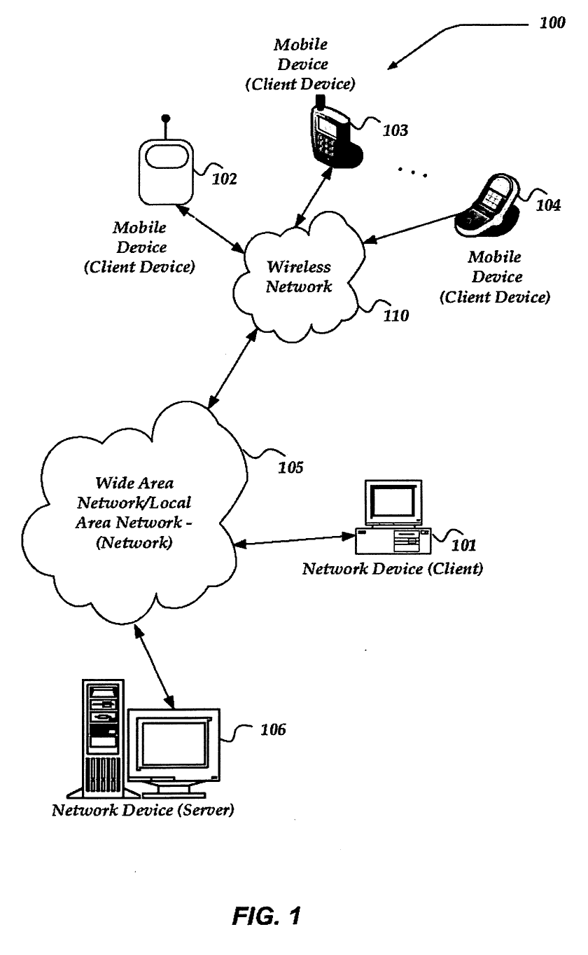

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, server network device 106, mobile devices (clients) 102-104, and client network device 101.

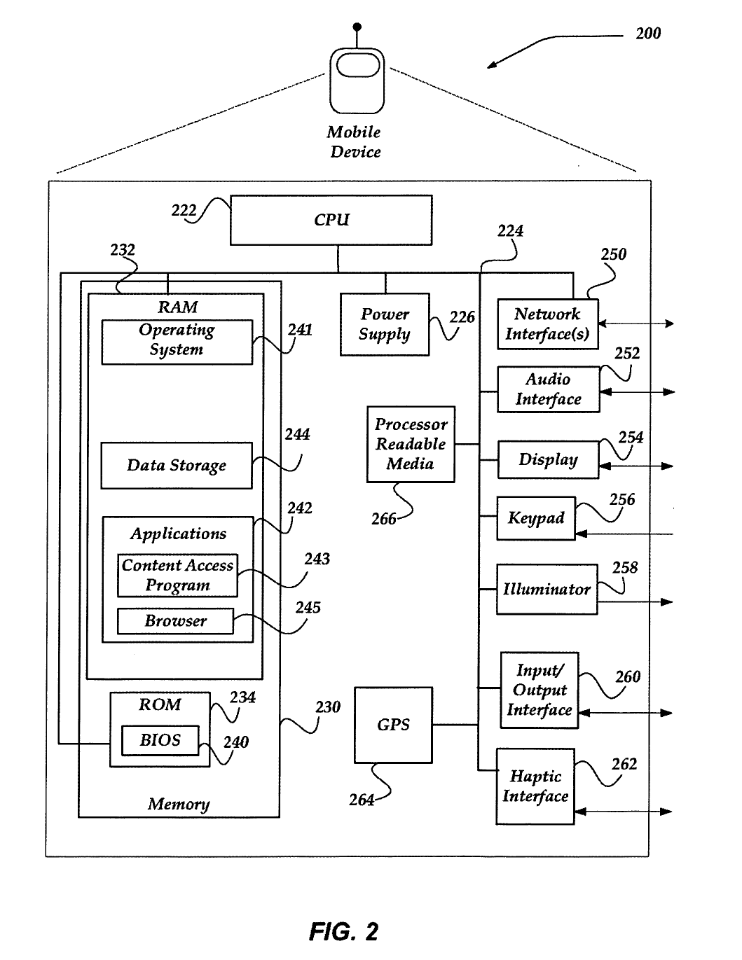

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, media players, video game consoles, multi-media computing platforms, integrated devices combining one or more of the preceding devices, and the like. As such, mobile devices 102-104 typically range widely in terms of capabilities and features. For example, a mobile telephone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol (WAP) message, and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one other client application that is configured to receive content from another computing device. The client application may include a capability to provide and receive textual content, graphical content, audio content, and the like. This client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to process. Such information may be provided in a message, or the like, sent to server network device 106, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as Network Device 106, client device 101, or the like. However, the present invention is not limited to these message protocols, and virtually any other message protocol may be employed.

Mobile devices 102-104 and client network device 101 may further be configured to include a client application that enables a user to log into a customer account that may be managed by another computing device, such as server network device 106. Such customer account, for example, may be configured to enable the user to search for content, browse web pages, select content for purchase, and select uses for the selected content, or the like. However, participation in these activities may also be performed without logging into a customer account.

Client network device 101 may include virtually any computing device capable of communicating over a network to send and receive information, including social networking information, or the like. The set of such devices may include devices that typically connect using a wired or wireless communications medium such as personal computers, multiprocessor systems, microprocessor-based or programmable consumer electronics, network PCs, network appliances, or the like.

Wireless network 110 is configured in part to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, Wifi networks, Wimax networks, cellular telephone networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple server network device 106 and its components with other computing devices, including, client network device 101, and through wireless network 110 to mobile devices 102-104. Network 105 is enabled to employ any form of processor readable media for communicating information from one networked electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between server network device 106, client device 101, and other computing devices.

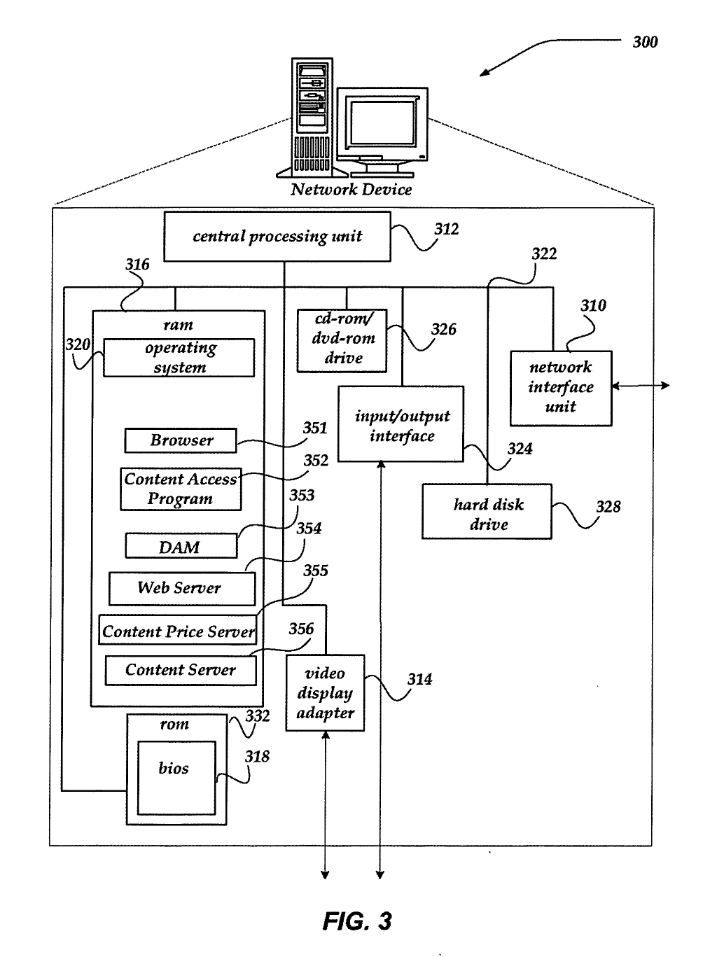

One embodiment of server network Device 106 is described in more detail below in conjunction with FIG. 3. Briefly, however, server network device 106 may include any computing device capable of connecting to network 105. Further, server network device 106 enables one or more server applications to communicate with clients and/or other server applications operating on other computing devices. The server applications can include, but are not limited to, one or more of content server 356, web server 354, content price server 355, and/or Digital Asset Management server 353. Further, server network device 106 can be arranged to include client applications such as browser 351, content access program 352, and the like.

Furthermore, although FIG. 1 illustrates server network device 106 as a single computing device, the invention is not so limited. For example, one or more functions or applications of server network device 106 may be distributed across one or more other network devices without departing from the spirit and scope of the invention.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264, and processor readable media 266. Media 266 may include, but is not limited to, hard discs, floppy disks, memory cards, optical discs, and the like. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is arranged for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store social networking information including vitality information, or the like. At least a portion of the social networking information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may further include browser 245 and content access program 243.

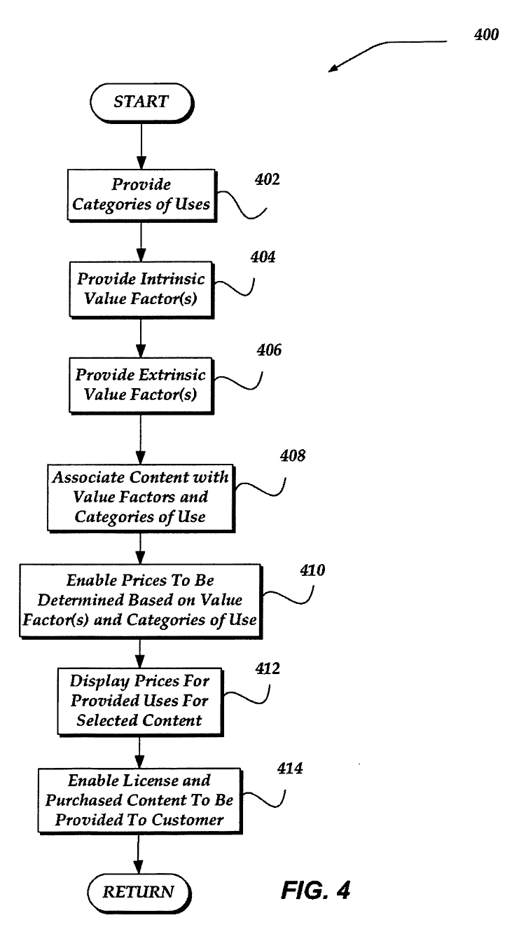

Content access program 243 may be configured either individually or in combination with browser 245 to enable searching and displaying of pages of selected content that is available for purchase for one or more uses that can be selected from predetermined categories. Program 243 can also enable a customer to aggregate categories of use. In one embodiment, content access program 243 enables a user to provide intrinsic value factors and/or extrinsic value factors for content that is subsequently priced in part on these factors and made available for purchase by customers over a network. Various embodiments of the processes for content access program 243 are described in more detail below in conjunction with FIGS. 4-11.

### Illustrative Network Device

FIG. 3 shows one embodiment of a network device, according to one embodiment of the invention. Network device 300 may include many more components than those shown. The components shown, however, are sufficient to disclose an illustrative embodiment for practicing the invention. Network device 300 may be arranged to represent, for example, server network device 106 or client network device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices with processor readable media, such as hard disc drive 328, tape drive, optical drive, memory card, and/or floppy disk drive. The mass memory stores operating system 320 for controlling the operation of network device 300. It is envisioned that any general-purpose or mobile operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, or network interface card (NIC).

The mass memory as described above illustrates another type of processor-readable media, namely computer storage media. Computer storage media may include volatile, nonvolatile, removable, and non-removable processor readable media implemented in any method or technology for storage of information, such as processor readable instructions, data structures, program modules, or other data. Examples of computer storage media include RAM, ROM, EEPROM, flash memory or other memory technology, CD-ROM, digital versatile disks (DVD) or other optical storage, memory cards, magnetic cassettes, magnetic tape, magnetic disk storage or other magnetic storage devices, or any other medium which can be used to store the desired information and which can be accessed by a computing device.

The mass memory also stores program code and data. One or more applications 350 can be loaded into mass memory and run on operating system 320. Examples of application programs that may be included are transcoders, schedulers, calendars, database programs, word processing programs, HTTP programs, customizable user interface programs, IPSec applications, encryption programs, security programs, VPN programs, SMS message servers, IM message servers, email servers, account management and the like.

If network device 300 is arranged as a client device, the client applications may include browser 351 and/or content access program 352. However, if network device 300 is arranged to operate and/or as a server, other serving applications may also be included, such as DAM 353, Web server 354, Content Price server 355, Content server 356, and the like. Furthermore, one or more of these serving applications may be arranged on one or more network devices dedicated to providing computing resources.

Content Price server 355 may be arranged to receive and process categories of use, intrinsic value factors, extrinsic value factors, and customized uses, customized pricing information, and the like. Content Price server 355 can preprocess information/data, process information/data in real time, or some combination of both to determine a price for a customer of selected content for one or more predetermined categories of use for the selected content. Also, the determination of the price can be based on one or more extrinsic value factors, intrinsic value factors, and predetermined categories of use. Furthermore, the determination of the price can be relatively static or dynamically updated in response to one or more changes to the information/data employed for determinations by Content Price Server 355. Generally, information and/or data can be provided for processing/preprocessing/determinations to Content Price Server 355 by one or more other servers, RSS feeds, APIs, applications, scripts, manual edits, third party sources, content providers, and the like.

Content server 356 can be arranged to provide access to content identification information so that the determined prices can be associated with the selected content. Web server 354 may also be arranged to provide the price information for selected content as a service to sources and/or resellers of selected content to customers. DAM 353 may also be arranged to incorporate the price information provided by Content Price server 355. Additionally, network device 300 is arranged to enable one or more of the processes described below in conjunction with FIGS. 4-11.

### Generalized Operation

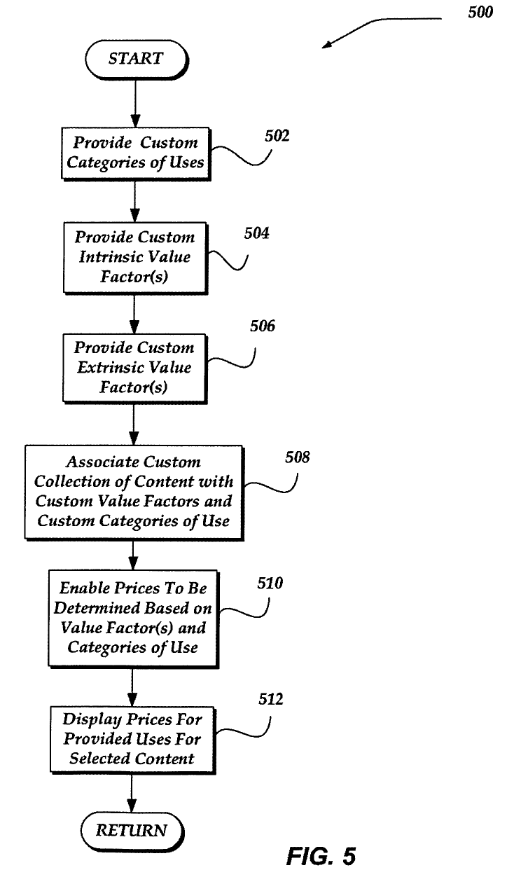

The operation of certain aspects of the invention will now be described with respect to FIGS. 4-8. FIG. 4 provides a general logical flow diagram, while FIGS. 5-8 provide examples of particular aspects of the processes to further illustrate the invention.

Thus, FIG. 4 illustrates logical flow overview 400 generally showing one embodiment of a process for determining prices for selected content based on one or more intrinsic and/or extrinsic value factors. Moving from a start block, the process steps to block 402 where one of a plurality of categories of use is provided. For example, these categories can include, but are not limited to, all uses, above the line, below the line, internal, editorial, and Web Only. Additionally, at least one of the pluralities of categories of use can include a term of use, e.g., perpetual use or a fixed period of time. At block 404, the process is provided with at least one intrinsic value factor, as discussed above. Stepping to block 406, the process is provided with at least one extrinsic value factor, as discussed above.

Additionally, the extrinsic and intrinsic value factors and categories of use can be provided in one or more manual or automated ways, either singly or in combination, including, but not limited to, a Real Simple Syndication (RSS) feed, an Application Programming Interface (API), a program, a script, manual entry, and the like.

The process subsequently flows to block 408 where units of content are associated with the provided categories of use, intrinsic value factors, and extrinsic value factors. This association can be performed directly and/or indirectly with one or more data structures, databases, data stores, and the like. Also, as discussed elsewhere, the categories of use, intrinsic value factors, and extrinsic value factors, can be provided by one or more third party sources that can be separate from the actual source and/or author of the content. One or more methodologies may be employed to provide the categories of use and value factors, including, but not limited to, an API, RSS feed, manual editing,

At block 410, the process enables prices to be determined for content based on the intrinsic value factors, extrinsic value factors, and categories of use. The determining of the prices can occur in advance of the selection of content by the customer or it can occur in response to the customer's actions, i.e., selecting content for pricing.

At block 412, the determined prices for selected content are displayed for the customer for each of the available predetermined categories of use. In one embodiment, the determined prices are displayed at a user interface provided by a content provider that receives content from one or more content creators. In other embodiments, the determined prices are provided to resellers of content through an application programming interface (API), Real Simple Syndication (RSS) feed, a link to a page provided by a source and/or provider of content, or some other intermediate mechanism that enables substantially the same prices to be provided to a customer by a content provider and a reseller of selected content. Additionally, in some embodiments, the derived prices are dynamically updated based at least in part on one or more changes to at least one of the intrinsic value factor, extrinsic value factor, and weight.

At block 414, if the customer has purchased the selected content, the process enables a unit of the content to be provided to the customer along with a license to the predetermined category of use that the customer has paid for. In one embodiment, the unit of selected content could be a downloadable electronic file or stream of data, such as an audio file, video file, picture file, video stream, audio stream, and the like, over a wired and/or wireless network. In another embodiment, the unit of selected content could be provided as an electronic file on a removable processor readable media, such as a floppy disk, disc drive, optical disc, Flash Drive, and the like. In still other embodiments, the unit of content could be provided with a tangible and/or intangible product, such as a calendar, screen saver, poster, mouse pad, apparel, accessory, and the like. Next, the process returns to performing other actions.

FIG. 5 illustrates a logical flow overview 500 of a process for customizing categories of use and/or pricing for content that is subsequently displayed for sale to one or more customers. Moving from a start block, the process steps to block 502 where custom categories of use are provided. These categories of use can be custom tailored to a particular customer based at least in part on one or more of a customer profile, typical applications for a particular industry, events, geographic location of the customer, discounts, markups, and/or promotions. In one embodiment, the customer is provided with an interface for customizing one or more groupings of one or more of the predetermined uses.

At block 504, the process provides custom intrinsic value factors for at least a portion of the available content. These customized intrinsic value factors can reflect custom formats, modifications, sizes, and the like. Flowing to block 506, the process provides custom extrinsic value factors. These customized extrinsic value factors can include customer specific discounts, markups, geographic location of the customer, promotions, anniversaries, events, collections, industries, and other customer specific applications.

Advancing to block 508, the process associates a custom collection of content with the custom uses, intrinsic value factors, and extrinsic value factors. This association can be performed directly and/or indirectly with one or more data structures, databases, data stores, and the like. Also, as discussed elsewhere, the custom categories of use, custom intrinsic value factors, and custom extrinsic value factors, can be provided by one or more sources that can be separate from the actual source of the content.

Flowing to block 510, the process enables prices to be determined for content based on the custom intrinsic value factors, custom extrinsic value factors, and custom categories of use. The determining of the prices can occur in advance of the selection of content by the customer or it can occur in response to the customer's actions, i.e., selecting content for pricing.

At block 512, the prices for selected content are displayed for the customer for each of the available custom categories of use. In one embodiment, the determined prices are displayed at a user interface provided by a content provider that receives content from one or more content creators. In other embodiments, the determined prices are provided to resellers of content through an application programming interface (API), a link to a page provided by the content provider, or some other intermediate mechanism that enables substantially the same prices to be provided to a customer by the content provider and a reseller of selected content. Next, the process returns to performing other actions.

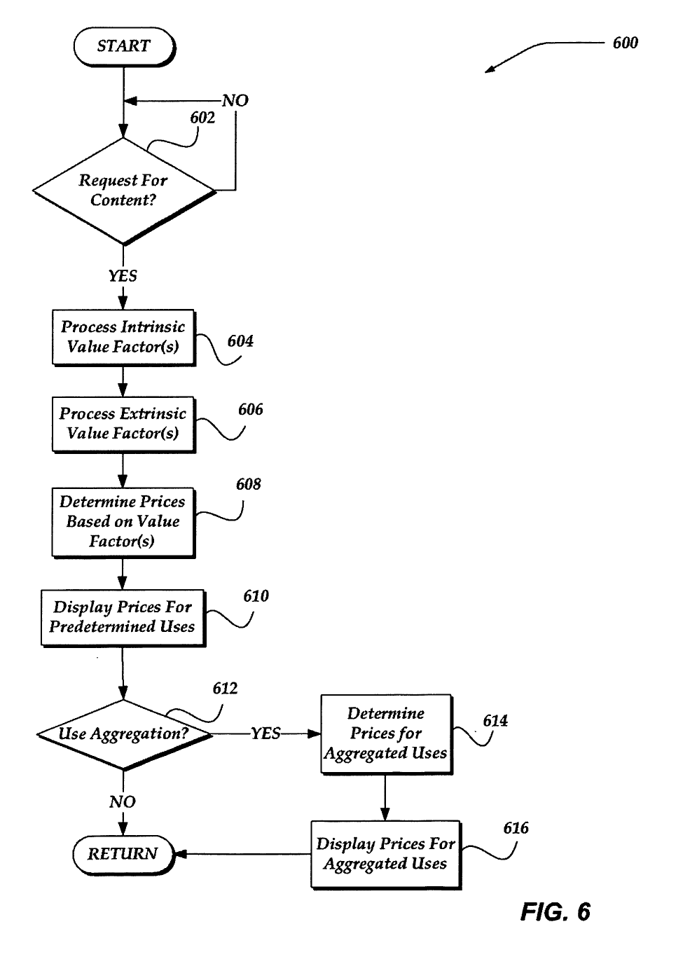

FIG. 6 illustrates a flow diagram for overview 600 of a method for determining prices for categories of use for content in response to their selection by a customer. Moving from a start block, the method moves to decision block 602, where a determination is made as to whether the customer is selecting content that is associated with at least one predetermined category of use. If not, the method waits until the determination is positive and then steps to block 604 where at least one of the intrinsic value factors associated with the selected content are processed. For example, the processing of the intrinsic value factors can include one or more of the processing steps that follow: normalization, functional analysis, weighting, coalescing, aggregation, and statistics. The intrinsic value factors can include at least the elements discussed above for FIG. 4, and elsewhere in the specification.

At block 606, the method processes at least one of the extrinsic value factors associated with the selected content. The extrinsic value factors can include at least the elements discussed above for FIG. 4, and elsewhere in the specification. The processing of the extrinsic value factors can include one or more of the processing steps that follow: normalization, functional analysis, weighting, coalescing, aggregation, and statistics. Flowing to block 608, the prices for selected content for the previously provided predetermined uses are determined based on the processed intrinsic value factors and extrinsic value factors.

Moving to block 610, the method enables the display of the determined prices for the predetermined categories of use for the requested content. The determined prices can be displayed at a user interface provided by a content provider that receives content from one or more content creators. In other embodiments, the determined prices are provided to resellers of content through an application programming interface (API), a link to a page provided by the content provider, or some other intermediate mechanism that enables substantially the same prices to be provided to a customer by the content provider and a reseller of selected content. Additionally, although not shown, in at least one embodiment, the prominence of the display of the requested content is based at least in part on at least one of the predetermined categories of use.

At decision block 612, a determination is made as to whether or not a customer has aggregated two or more predetermined categories of use for the selected content. If false, the method moves to the return block and returns to performing other actions. However, if the determination at decision block 612 is affirmative, the method steps to block 614 where a price is determined for the aggregated categories of use. At block 616, the newly determined prices for the aggregated categories of use are displayed. Next the method returns to performing other actions.

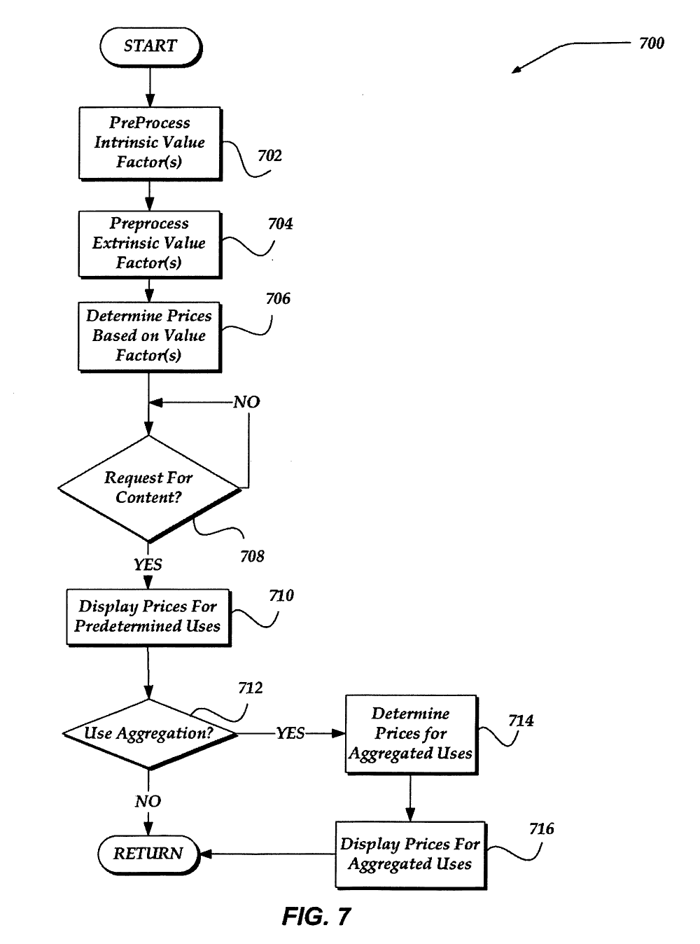

FIG. 7 illustrates a flow diagram for overview 700 of a method for determining prices for categories of use for content in advance of their selection by a customer. Moving from a start block, the method moves to block 702 where at least one of the intrinsic value factors associated with the selected content are preprocessed. For example, the processing of the intrinsic value factors can include one or more of the processing steps that follow: normalization, functional analysis, weighting, coalescing, aggregation, and statistics. The intrinsic value factors can include at least the elements discussed above for FIG. 4, and elsewhere in the specification.

At block 704, the method preprocesses at least one of the extrinsic value factors associated with the selected content. The extrinsic value factors can include at least the elements discussed above for FIG. 4, and elsewhere in the specification. The processing of the extrinsic value factors can include one or more of the processing steps that follow: normalization, functional analysis, weighting, coalescing, aggregation, and statistics. Flowing to block 706, the prices for selected content for the previously provided predetermined uses are determined based on the preprocessed intrinsic value factors and extrinsic value factors.

Advancing to decision block 708, a determination is made as to whether the customer is selecting content that is associated with at least one predetermined category of use. If not, the method waits until the determination is positive and then steps to block 710 where a display is provided for the previously determined prices for the predetermined categories of use. These previously determined prices can be displayed at a user interface provided by a content provider that receives content from one or more content creators. In other embodiments, the determined prices are provided to resellers of content through an application programming interface (API), Real Simple Syndication (RSS) feed, script, application, a link to a page provided by the content provider, manual edits, or some other intermediate mechanism that enables substantially the same prices to be provided to a customer by the content provider and a reseller of selected content. Additionally, although not shown, in at least one embodiment, the prominence of the subsequent display of the content is based at least in part on at least one of the predetermined categories of use.

At decision block 712, a determination is made as to whether or not a customer has aggregated two or more predetermined categories of use for the selected content. If false, the method moves to the return block and returns to performing other actions. However, if the determination at decision block 712 is affirmative, the method steps to block 714 where a price is determined for the aggregated categories of use. At block 716, the newly determined prices for the aggregated categories of use are displayed. Next the method returns to performing other actions.

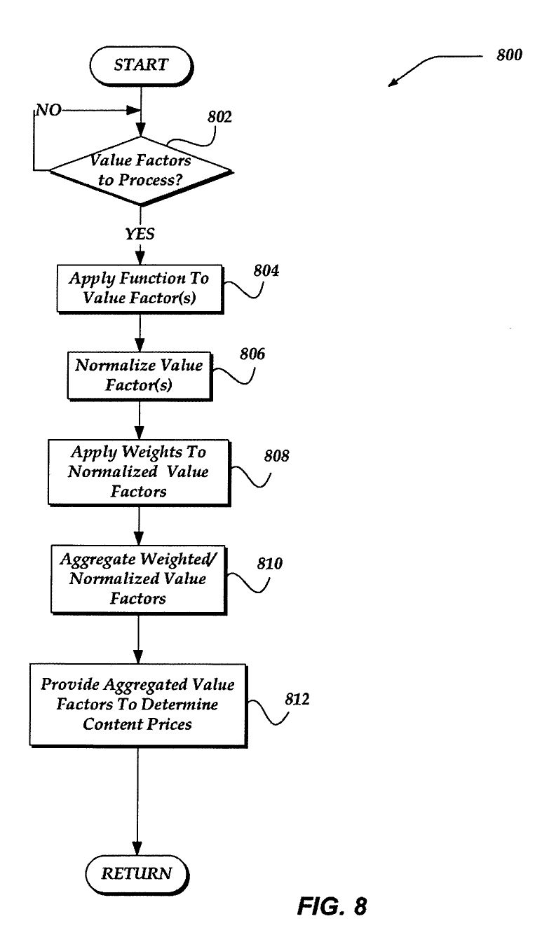

FIG. 8 illustrates a logical flow diagram overview 800 of a method to process value factors which can be generally applied to both intrinsic value factors and extrinsic value factors. Moving from a start block, the process flows to decision block 802 where a determination is made as to whether or not value factors have been provided for processing. The method waits until the determination is affirmative and advances to block 804 where, if applicable, functional operations are performed on the provided value factor. These functional operations can include arithmetic operations, rounding, frequency, equalization, logical operations, integer conversion, floating point conversion, statistical computations, coalescing, and the like.

Advancing to block 806, as appropriate the provided value factor is normalized to a scale and/or range provided for that particular type and/or kind of value factor. For example, each kind of the provided type of intrinsic value factors might be normalized to a scale of one to ten even if they were initially provided in different scales such as one to 100 or zero to five.

At block 808, appropriate weights are provided for the type and/or kind of value factor. For example, one or more of the extrinsic value factors might be associated with weights of 10% or less, where other kinds of the intrinsic value factors might be associated with weights of 50% or more.

Moving to block 810, the normalized and weighted value factors are aggregated by type. For example, the different kinds of intrinsic value factors are aggregated together and the different kinds of extrinsic value factors are aggregated together.

At block 812, the aggregated intrinsic value factors and the aggregated extrinsic value factors are subsequently provided for another process to determine prices for predetermined categories of use for selected content. In at least one embodiment, a change in one or more of the extrinsic and/or intrinsic value factors can be employed to dynamically adjust the aggregated amount of value factors over time. Additionally, one or more of the weights can be dynamically adjusted over time based at least in part on at least one change to one or more of the intrinsic and extrinsic value factors, and/or input from an API, RSS feed, manual editing, and the like. Next, the method returns to performing other actions.

It will be understood that each block of the above flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions executing on the processor provide steps for implementing the actions listed in the flowcharts discussed above.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Exemplary User Interface

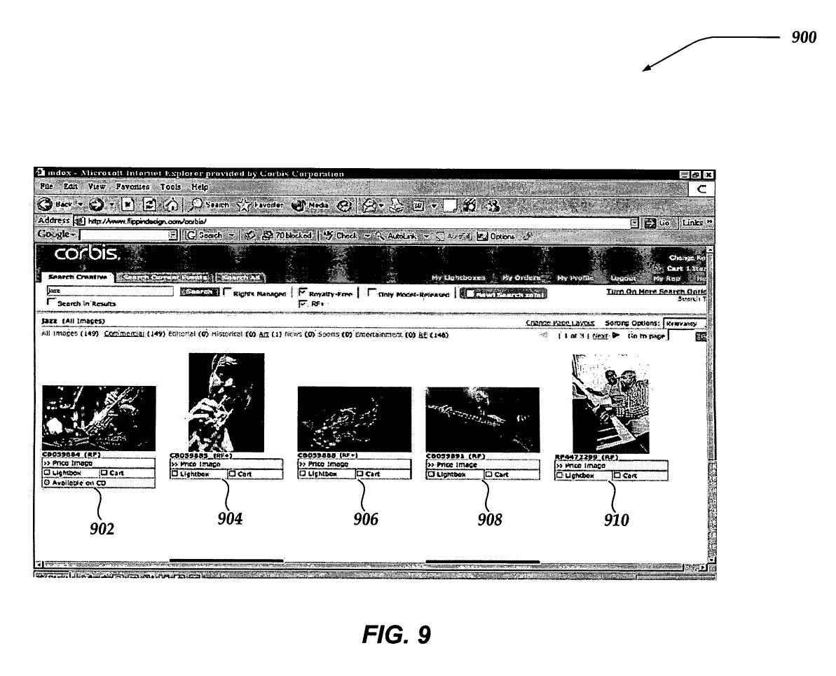

FIGS. 9, 10, and 11 illustrate exemplary pages that can be displayed to a customer to assist in selecting and purchasing content whose category pricing is determined by the invention.

FIG. 9 illustrates a display of page 900, which includes five images 902, 904, 906, 908, and 910 that are the result of a search on the word “jazz.” Two images (904 and 906) are displayed with an RF+ indicator and the other three images (902, 908, and 910) include RF indicators. In this embodiment, the RF+ indicator identifies the corresponding content (image) as being available in a pricing format that is substantially similar, but somewhat different in positive ways, to the royalty free pricing model. The other content (images 902, 908, and 910) display RF indicators that identify the standard royalty free pricing model.

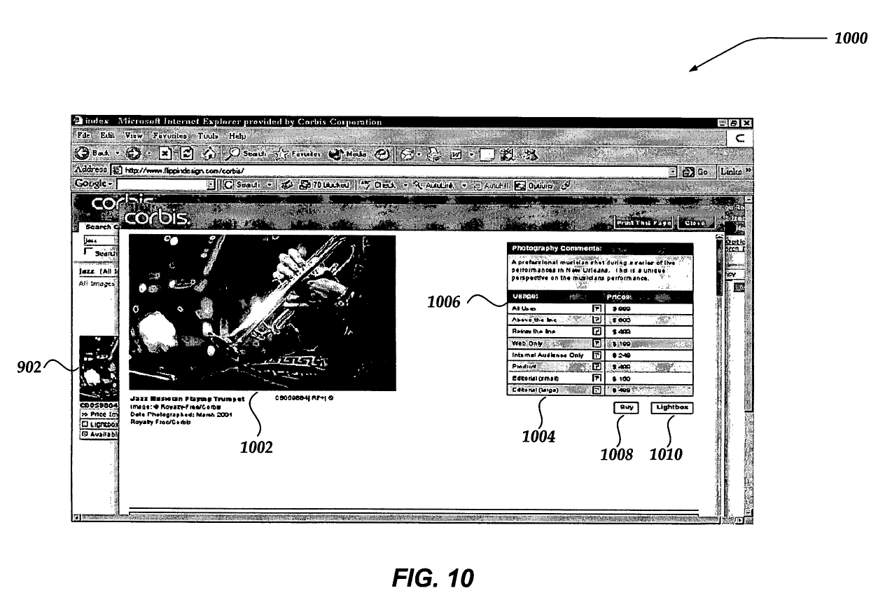

FIG. 10 illustrates a display of page 1000, which is the result of selecting image 902 in FIG. 9. Image 1002 is a higher resolution display of the selected content which includes its title and related usage information. Also, table 1004 is displayed which includes a plurality of predetermined categories of use and the determined prices for each category. Annotation 1006 can also include comments and/or text that indicate one or more factors that positively support a determined price for the selected content. Buy button 1008 is provided so that the customer can proceed to a check out facility and purchase the selected content. Also, light box (shopping cart) button 1010 is provided so that the customer can temporarily store the selected content for future consideration as a purchase. Additionally, although not shown, in at least one embodiment, the prominence of the display of content is based at least in part on one of the predetermined category of use. Furthermore, although not shown, a visual image may be displayed either singly or in combination with the annotation to indicate a prominence of selected content.

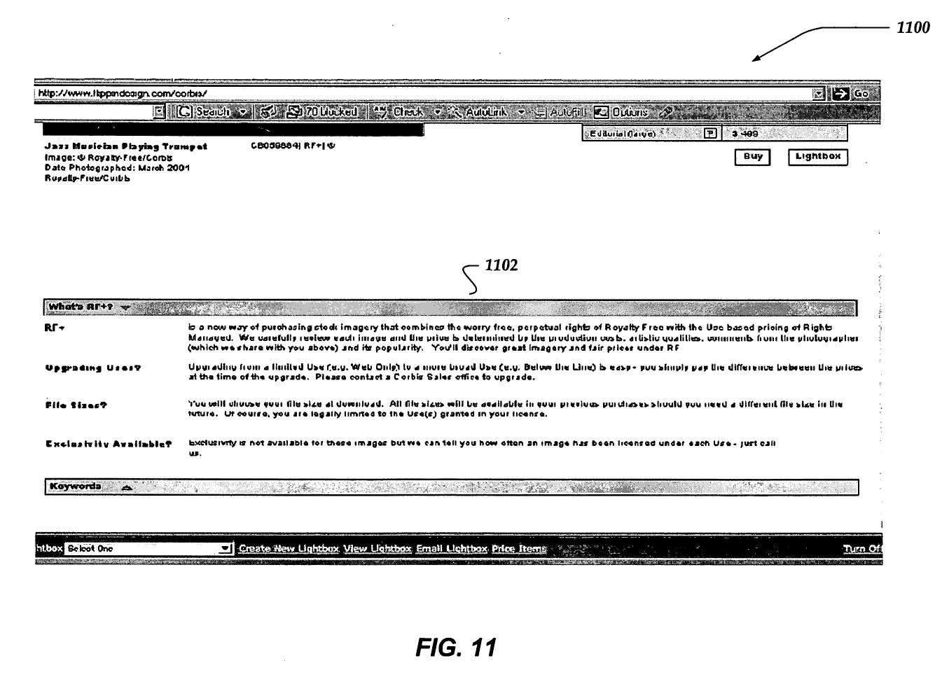

FIG. 11 illustrates a display of page 1100, which depicts help information 1102 that explains the royalty free plus pricing model to the customer. Help information 1102 also includes explanations regarding upgrading uses, files sizes, and exclusivity options.

### Example Architecture

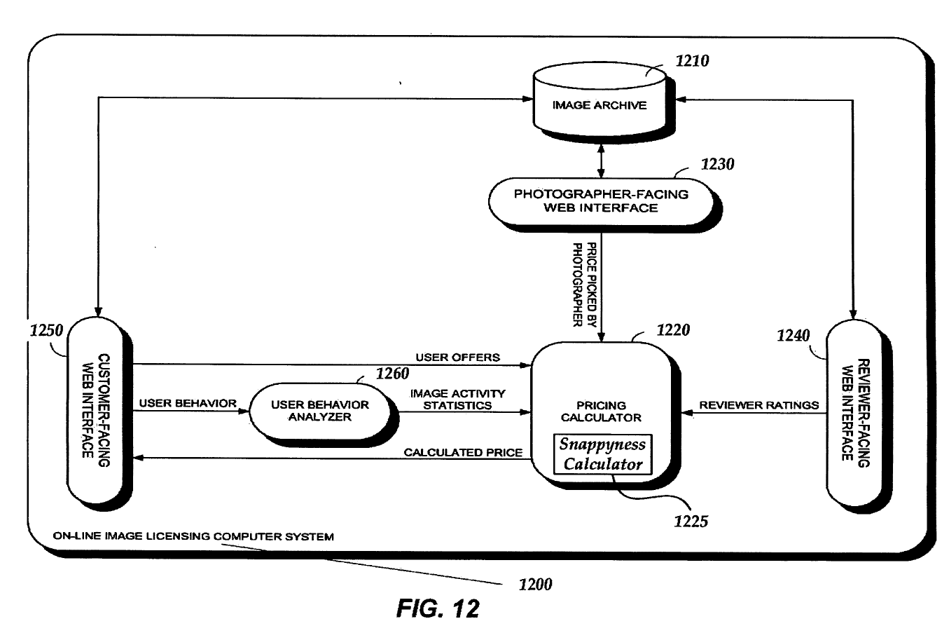

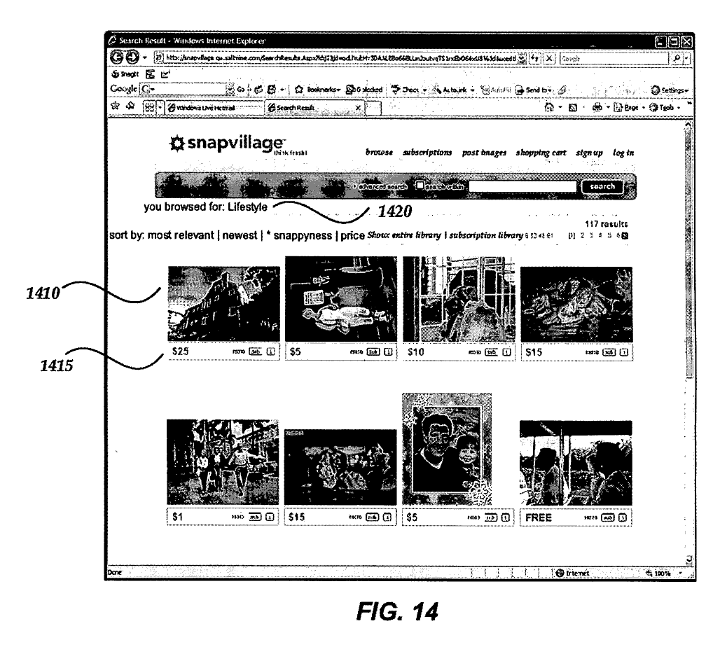

Example embodiments are now described with reference to a content licensing system in the form of an on-line photo licensing system. Other embodiments may involve other types of content, and may include many other factors than those discussed below. Reference is now made to FIG. 12, which is a simplified block diagram of an on-line photo licensing computer system 1200 with dynamic price adjustment, in accordance with an embodiment of the present invention. System 1200 licenses images from a large image archive 1210. The images in archive 1210 have published prices associated therewith, as illustrated in FIG. 14 herein below. The published prices are generally initialized with a seed value, such as an initial selling price suggested by the photographer, current image owner, or other content provider. In addition, or alternatively, the content provider may a minimum price, a maximum price, a volume discount, a maximum allowable change in price over a period of time, and/or other seed values. The initial prices is generally published with the corresponding photo, but may be used as input to calculate an initial published price. The published price may then change based on image activity. Shown in FIG. 12 is a price calculator 1220, which dynamically adjusts the published prices for the images.

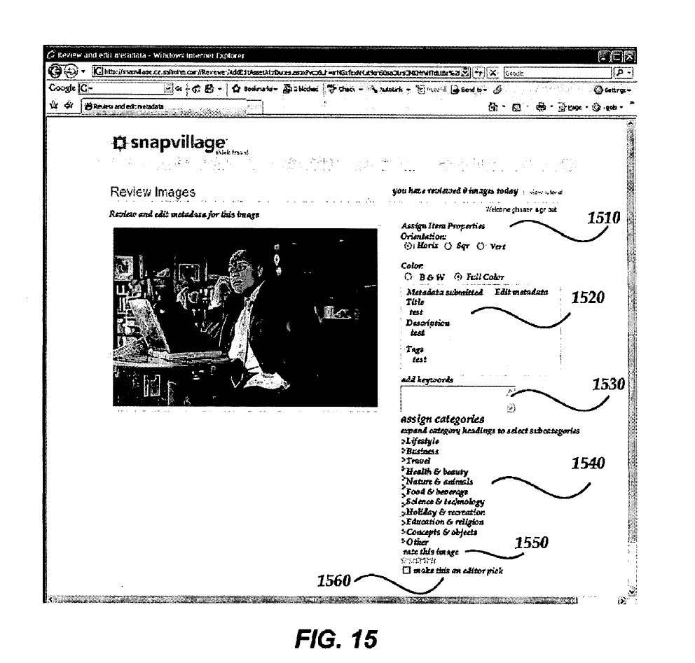

Price calculator 1220 is part of the overall on-line licensing computer system 1200. System 1200 includes a photographer-facing web interface 1230, which is used by photographers or current content owners for uploading their images to system 1200 and for setting or suggesting prices, as described in detail herein below with respect to FIGS. 14A-14D. In some embodiments, the photographer-facing web interface also enables a content owner to review snappyness data and current pricing information, and to manually adjust prices. Images uploaded via web interface 1230 are archived in image archive 1210. System 1200 also includes a reviewer-facing web interface 1240, which is used by reviewers for cataloging and rating images from archive 1210, as described in detail herein below with respect to FIG. 15. System 1200 also includes a customer-facing web interface 1250, which is used by customers for browsing image archive 1210 and possibly licensing one or more images for their editorial, commercial, or other use, as described in detail herein below with respect to FIGS. 14, 16 and 17.

Pricing calculator 1220 receives inputs from each of the web interfaces 1230, 1240 and 1250, and determines price adjustments to recommend to content owners or to automatically apply to current published prices for the images in image archive 1210. The inputs may be received dynamically or accessed from a file during a batch process. Similarly, price adjustments may be determined dynamically or during a batch process. The price calculator includes a snappyness calculator 1225 that determines a snappyness score based on input received from customer-facing web interface 1240 and reviewer-facing web interface 1250. Web interface 1230 allows photographers to pick their own prices as seed price parameters or price suggestions. The price settings or suggestions made by the photographers are generally considered intrinsic factors that are input to price calculator 1220.

Web interface 1240 allows reviewers to rate images. An overall review rating or numerous ratings aspects are generally considered extrinsic factors. The ratings made by the reviewers are also input to the snappyness calculator of price calculator 1220. Web interface 1250 allows customers to browse and search for images, to mark them for future reference, to send them, or links thereto, to colleagues, to purchase licenses to images, or perform other actions. The customer behaviors identified by web interface 1250 are passed to a behavior analyzer 1260, which generates image activity statistics that are in turn also input to the snappyness calculator of price calculator 1220. Additionally, customers may make offers, such as proposed purchase prices or bids, and these are also input to price calculator 1220. The customer behaviors are also generally considered extrinsic factors.

Price calculator 1220 calculates a price adjustment. The price adjustment may be provided to the content owner, who may consider manually changing the price. Alternatively, the content owner may allow the price calculator may dynamically adjust the currently published prices for the images in archive 1210. The price adjustment is based on the factors above, such as (i) the photographer price settings or suggestions, (ii) the reviewer ratings, (iii) the image activity statistics, and (iv) the user offers. It will be appreciated by those skilled in the art that price calculator 1220 encompasses a very wide variety of pricing models and formulas. Presented herein below are a few example models.
1. A photographer suggests a price for his image from a discrete set of options, and may manually change his price from time to time. The photographer's suggested price is used as the published price, and not automatically changed, but the snappyness and/or price adjustment may be provided for the photographer's consideration. Alternatively, the photographer's suggested price is used as a lower limit for the published price. In another alternative, the photographer's suggested price is used as an upper limit for the published price. The photographer may also provide a lower limit, an upper limit, and a suggested price.
2. A photographer picks an arbitrary price for his image, and may manually change his price from time to time. The price may be picked from a list of prices or price ranges. The photographer's picked price is used as the published price, and not automatically changed, but the snappyness and/or price adjustment may be provided for the photographer's consideration. Alternatively, the photographer's picked price is used as a lower limit for the published price; or alternatively, the photographer's picked price is used as an upper limit for the published price. The photographer may also provide a lower limit, an upper limit, and a picked price.
3. Customers offer a purchase price for an image, and photographers accept or decline. Photographers may review all offers and accept some, none, or all of them. Snappyness and/or price adjustment may be provided for the photographer's consideration.
4. A photographer may stipulate a “buy-out” price for an image, at which a customer can purchase an exclusive license to the image. Snappyness and/or price adjustment may be provided for the photographer's consideration in stipulating or changing the “buy-out” price.
5. The photographer's suggested price is used as an initial value for the published price. Price calculator 1220 dynamically calculates one or more numerical scores for an image, based on reviewer ratings and customer behavior (which may or may not include customer offers). The price calculator sets and/or modifies the image's published price accordingly. The price calculator may also limit the published price to an upper or lower limit that is provided by the photographer, predetermined, associated with a category to which the photo belongs, or other limiting criteria.
6. The photographer's suggested price is used as an initial value for the published price. Price calculator 1220 dynamically calculates one or more numerical scores for an image, based on reviewer ratings and customer behavior (which may or may not include customer offers). The price calculator may then provide the calculated snappyness and/or other scores to inform the corresponding photographer how well his image is faring. The photographer may manually reassign the photo to a different pricing category, or the pricing category may automatically reassign the photo to a different pricing category. The new category price is then used as the published price.

It will be appreciated by those skilled in the art that the online photo licensing system 1200 described in FIG. 12 may be embodied in a single server computer, such as network device 106 of FIG. 1, or distributed over a plurality of server computers that are communicatively coupled with one another. Each of the individual interfaces, 1230, 1240 and 1250, for example, may be embodied in a separate computer, in a single computer, or distributed over more than one computer.

### Example Screen Shots

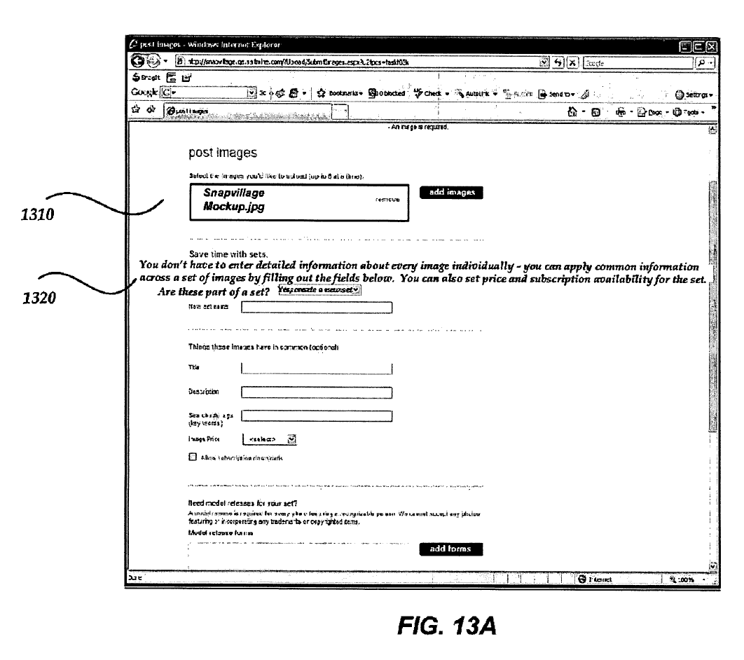

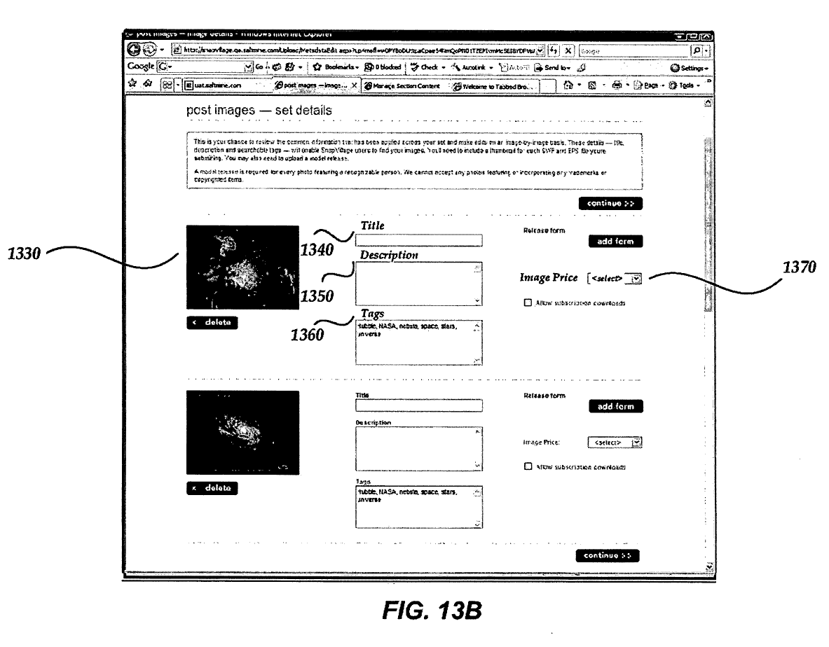

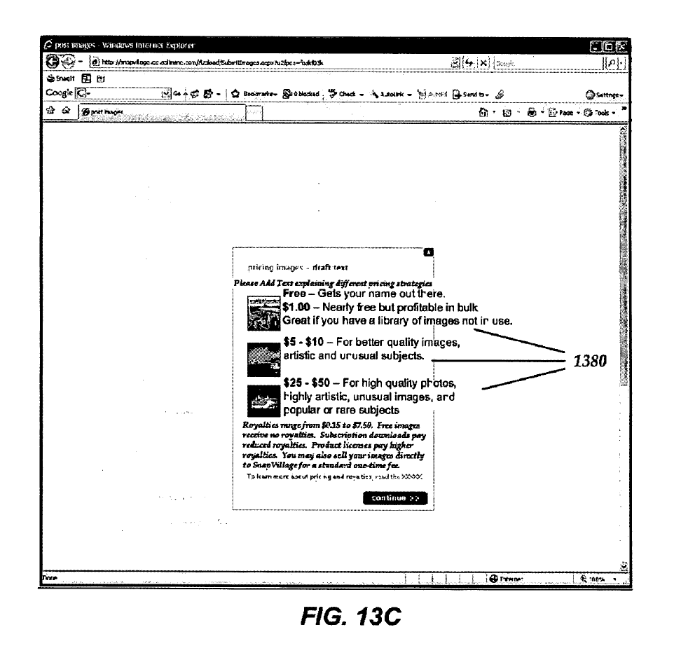

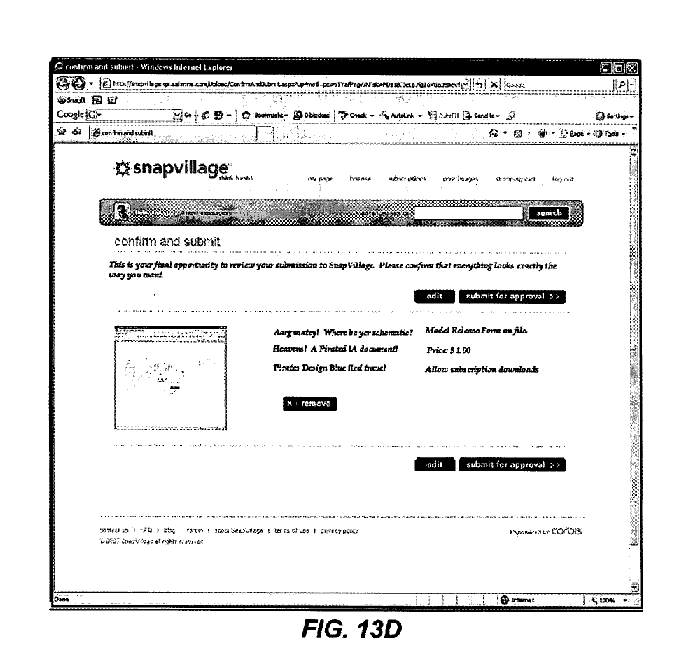

Reference is now made to FIGS. 13A-13D, which are example screen shots of a photographer-facing interface, such as photographer interface 1230 of FIG. 12, for uploading and pricing images. Shown in FIG. 13A is a screen shot of an interface including an upload control 1310 that allows a photographer to upload 1-5 images to system 1200. One or more set controls 1320 enable a photographer or a current image owner to organize images into sets. As shown in FIG. 13B, after the photographer has uploaded an image, such as image 1330, a data entry form enables the photographer to enter or set some metadata for each image, including a title 1340, a description 1350, one or more keyword tags 1360 or the like. The photographer may also enter or select an image price 1370. FIG. 13C illustrates dialog box with an explanation 1380 that may be provided to the photographer for setting or suggesting a price. For example, the explanation may suggest price ranges based on image quality, size, content, or other intrinsic characteristics. After setting metadata for one or more images, the photographer may submit his images for approval, as shown in FIG. 13D.

Reference is now made to FIG. 14, which is an example screen shot showing a search result of images, such as image 1410, with corresponding published prices, such as published price 1415. Search results, such as those in FIG. 14, are shown to customers who are searching or browsing images from image archive 1210, via customer-facing interface 1250. In this example screen shot, the images, including image 1410, are associated with a “Lifestyle” category 1420. As mentioned hereinabove, one pricing model used by pricing calculator 1220 is to set the published prices, such as published price 1415, according to the prices input by the photographers via photographer-facing web interface 1230.

Reference is now made to FIG. 15, which is an example screen shot of a reviewer-facing interface, such as reviewer interface 1240 of FIG. 12, for rating images. As shown in FIG. 15, the reviewer interface enables a reviewer to access and display an image from image archive 1210. The reviewer-facing interface includes a number of radio buttons, text entry boxes, drop-down menus, or other user interface controls that enable the reviewer to enter, edit, or otherwise associate information with the displayed image. For example, the reviewer may assign an image orientation, an indication that the image is in color, or other properties 1510. The reviewer may also review, enter, or edit a title, description, tags, or other metadata 1520. Similarly, the reviewer may review, enter, or edit search terms, or other keywords 1530. The reviewer may interact with a displayed tree structure or other groups to assign a category 1540 and sub-category to the image. The reviewer may further assign a rating. In this example, reviewer ratings are in the form of a one to five-star rating 1550. In addition, a reviewer can assign an “editor's pick” status 1560 to an image. Any or all of the assigned review information may impact the price of the image.

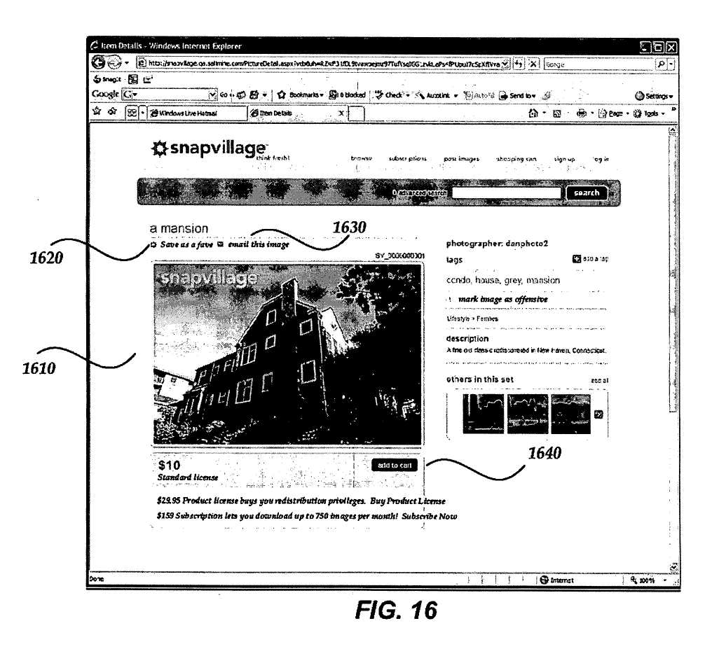

Reference is now made to FIG. 16, which is an example screen shot of a customer-facing interface, such as customer-facing interface 1250 of FIG. 12, for browsing and licensing images. As shown in FIG. 16, the customer interface enables a customer to search for, browse, and view images and related data from archive 1210. A customer may also perform certain operations through user interface controls such as buttons, links, and the like. For example, a customer may add an image 1610 to a list of favorites by selecting a favorite's link 1620. Selecting the favorite's link adds an image identifier to the customer's list of favorite images, so that the customer may use the favorites list to recall the image and related data. The customer may also e-mail image 1610, or a link thereto, to a friend by a selecting an email link 1630. The customer may add image 1610 to a shopping cart by selecting an add button 1640. Other possible actions include adding a tag to the image, marking the image as offensive, selecting alternate licensing options, selecting a related image, returning to a previous image, or the like. Additionally, the customer-facing interface may enable a customer to enter a price in the form of a bid or counter-offer for a selected image.

These and other customer actions are recorded and analyzed, by user behavior analyzer 1260, to generate image activity statistics. Customer actions are generally considered extrinsic factors.

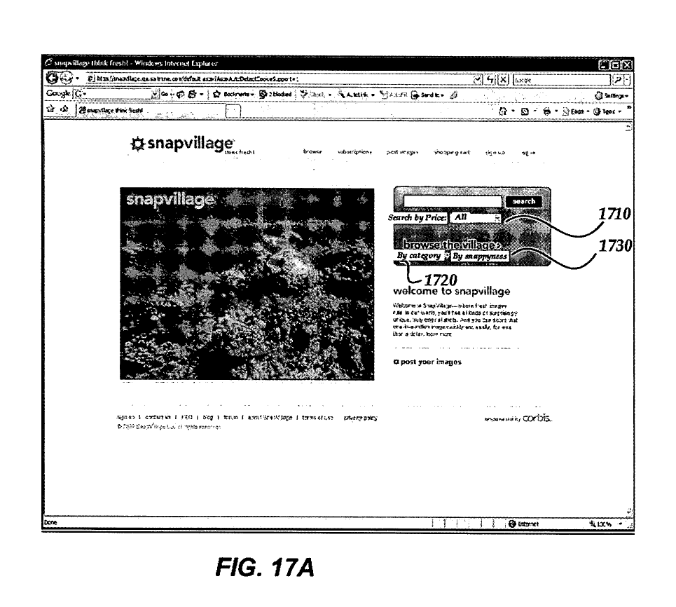

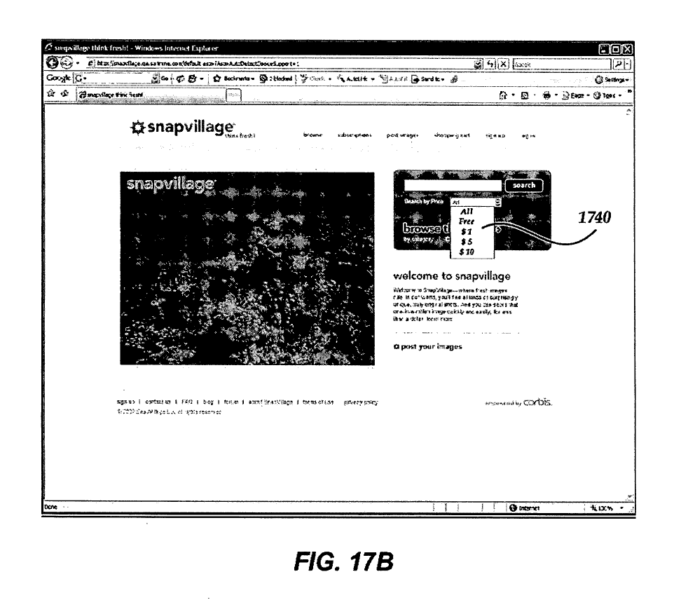

Reference is now made to FIGS. 17A and 17B, which are example screen shots of a customer-facing user interface for searching for images within an archive. The customer-facing user interface enables a customer to enter search terms and/or to optionally indicate a published price, to restrict or filter the search. Shown in FIG. 17A is a control 1710 for selecting a published price within a search request. For example, the customer may select from a drop-down list of published prices, such as list 1740 shown in FIG. 17B. Shown in FIG. 17A is a control 1720 for specifying a search, or browsing by a category, such as lifestyle images, business images, travel images, or the like.

A control 1730 enables a customer to request a search or browse images by “snappyness.” Snappyness is a term that refers to a score assigned to an image, based on factors including reviewer ratings and/or image activity, such as those discussed above. In one embodiment, the snappyness score generally reflects a popularity of an image, as evidenced by user behaviors. As discussed above, example behaviors include users making the image a favorite, users selecting the image from a list of search results, users downloading the image, users adding the image to a shopping cart, users licensing the image, or the like. The snappyness score may also reflect a degree of rise or fall in popularity of the image, an amount of revenue generated by the image, or other extrinsic factors.

### Example Logic Flow

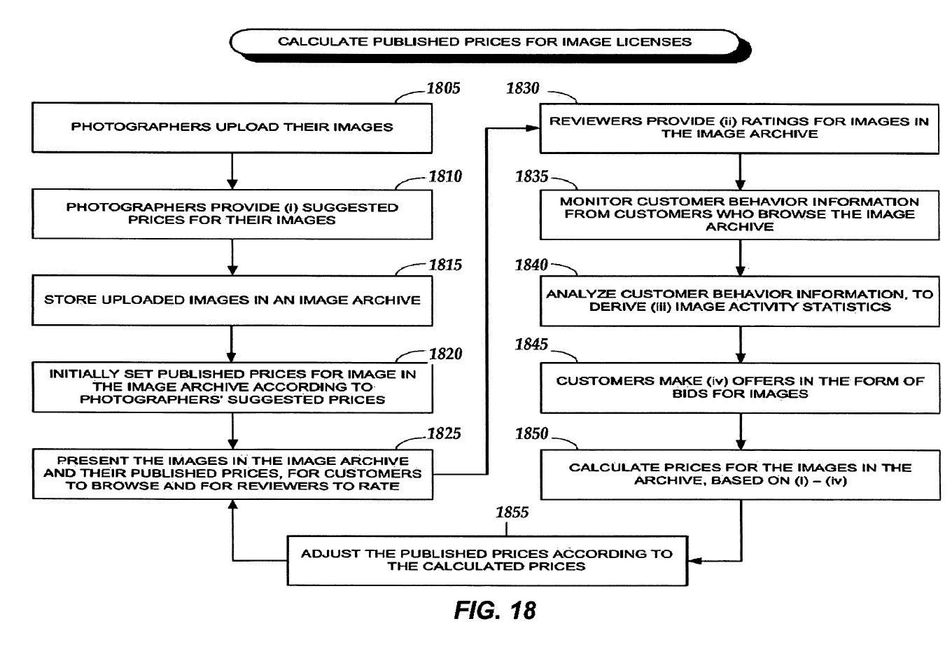

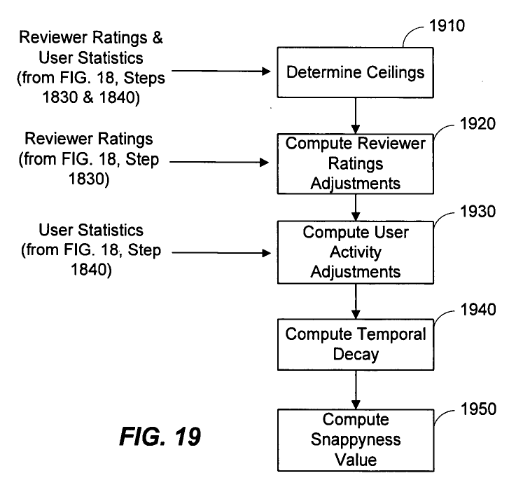

Reference is now made to FIG. 18, which is a simplified flowchart of a method for dynamically setting and adjusting published prices for images, in accordance with an embodiment of the present invention. At step 1805, an on-line content licensing system, such as system 1200 of FIG. 12 receives uploaded content from photographers or other content owners. At step 1810, the on-line content licensing system receives suggest prices from the content owners for their corresponding uploaded content. The on-line content licensing system may also receive suggested upper and lower price limits, selected price categories, or other initial data. At step 1815 the uploaded content items are stored in content archive, such as image archive 1210.

At step 1820 the published prices for the content items are set according to the suggested prices received from the content owners. In one embodiment, the suggested prices are initial prices, which are subsequently adjusted dynamically, based on reviewer ratings, customer behaviors, or other extrinsic factors. At step 1825 the content items and their corresponding published prices are made accessible to customers for browsing or searching.

The content items are also provided to reviewers for rating. The published price may or may not be provided to the reviewers. At step 1830 reviewers provide ratings, keywords, properties, or other reviewer information for the content items in the image archives Reviewers may assign “editor's pick” status to select images. Each reviewer rating or other reviewer information may have be given a weight or have a pre-defined weight. In one embodiment, the weighted reviewer rating or other reviewer information may be combined to calculate a single reviewer score for a content item.

At step 1835 customer behavior is monitored, from customers who browse the content archive, to determine content activity statistics. As discussed above, examples of such behavior includes marking images as favorites, selecting images from search result lists, sending images, or links thereto, to other users, downloading images, adding images to a shopping cart, and purchasing licenses to images. Lack of activity for a content item (e.g., temporal decay), may also be used in determining content activity statistics. Similar to reviewer information, a weight may be associated with each behavior. At step 1840, the monitored customer behavior is analyzed, to derive content activity statistics. Content activity statistics are generally calculated for each content item, but aggregated activity statistics may also be calculated. A weighted behavior score may be determined for each content item, but may also be combined with groups of the content items to determine a group behavior score. Groups may include categories of content, content provider, or the like.

At step 1845 the on-line licensing system may receive customer offers in the form of bids for content stored in the content archives The actual amount of the offer, or a percentage difference from the suggested price, may be used as an offer factor. The offer factor may be combined into the other activity statistics discussed above, or treated separately. The offer factor, customer behavior information, and reviewer score may be combined to determine overall snappyness. Alternatively, combinations of only two of these factors may be used to determine overall snappyness.

At step 1850, snappyness scores are dynamically calculated and used to dynamically calculate content prices based on a combination of the information from content providers, reviewers, and/or customers. In one embodiment, content prices are calculated based on (i) the prices suggested by content owners at step 1810, (ii) the ratings received from reviewers at step 1830, including selection of images for “editor's pick”, (iii) the image activity statistics derived at step 1840, and (iv) the offers made by customers at step 1845. In another embodiment, the content prices are also limited by upper and lower limits provided by content owners, imposed by content categories, or otherwise applied. Each factor may be given a weight to have different affects on the calculated price. The snappyness score and/or the price adjustments may be provided for the content owners to review. The content may also be ranked according to snappyness and/or price adjustments. At step 1855, the current published prices for the content in the content archive are adjusted according to manual changes from the content owners, according to automatic changes to the prices calculated at step 1850, or according to changing the content to different price categories. The updated prices are presented to customers at step 1825, and the process may repeat.

### Example Snappyness Processing

Snappyness is a type of extrinsic value factor that takes into account both reviewer information and content activity. Reviewers may be experts in the field of the content and may be tasked with reviewing the content. In addition, or alternatively, reviewers may include customers of the content. Content activity generally includes user behaviors relative to content, as discussed above.

Popular media, e.g. newspapers and magazines and websites, generally provide expert reviews of popular media such as movies and music recordings. Such reviews are often summarized through a ranking system. For example, a one to five star ranking system is common. Some web sites also enable end users to give a review of media, such as images, music, books, or movies. Often, these reviews are summarized through a ranking system similar to that used to rank the expert reviews. Typically, expert reviews and user reviews are treated independently and are used for display or “showcasing.” For example, an “expert ranking” that reflects the average ranking of a media asset by experts might appear in a web page next to the average ranking by users.

Some websites also indicate some content activity. For example, some electronic commerce websites indicate that a percentage of users purchased a product after viewing the product on the website. Similarly, some websites indicate that another percentage of users purchased a different product after viewing the first product. There is typically no indication of any relationship between purchases (or other user behaviors) and the reviews. Similarly, some websites rank search results, most frequently purchased products, or most frequently viewed web pages. There is typically no indication of any relationship between the rankings and the reviews. There is also no indication of any relationship among the listed search results (or listed products), based on a consideration of both reviews and rankings that are determined from user behaviors. Snappyness provides such an indication.

As previously discussed, snappyness can be used for many purposes. For example, snappyness can be used by the price calculator 1220 to dynamically adjust prices. Snappyness can be used to rank, or otherwise order search results that are presented to the user. Snappyness can be used explicitly as a sort index that a user can select to order lists of content. Snappyness can be used to select images to showcase on a web page. Snappyness can be used to provide guidance to the photographer as to whether to modify their recommended pricing. Snappyness can be used to inform the photographer as to the popularity of their images. Snappyness can be used to rank content providers, based on how well each provider's set of content is ranked. Numerous other applications are possible.

Reference is now made to FIG. 19, which is a simplified flowchart of a method for determining a snappyness score for a single content item, in accordance with an embodiment of the present invention. For ease of discussion, this example method determines a snappyness score from 0 to 100 points for a content item such as an image. The determination can be implemented with hardware and/or software. This example method takes into account seven categories of inputs. The first two inputs are reviewer inputs: (1) reviewer ratings and (2) editor's pick selections referred to in describing FIG. 18, step 1830. The next five inputs are content activities based on user behaviors, which are generally referred to in describing FIG. 18, steps 1835 and 1840. In this embodiment, the content activities include: (3) the number of times an image was downloaded, (4) the number of times an image was selected as a favorite by a customer (sometimes referred to herein as favorited), (5) the number of times an image was viewed (e.g. selected from a list for viewing), (6) the number of times an image was tagged, and (7) the number of public comments made by customers. A snappyness weight may be predefined for each input category. For example, the reviewer ratings category may be pre-assigned a higher snappyness weight than other input categories.

For purposes of this discussion, snappyness is being computed for a specific time interval and that all user behavior statistics are computed for this interval. For example, “the number of times an image was viewed” is taken to mean the number of times an image was viewed since the last time that snappyness was computed. It will be appreciated by those skilled in the art that snappyness can be computed at regular time intervals or on an ad hoc basis. It will be further appreciated that the time interval's across which to compute snappyness may be arbitrary.

At step 1910 “ceiling” or maximum values are determined for each category of input that will be taken into account in the snappyness computation. The ceiling value generally refers to a maximum value that is input or a maximum value for a monitored behavior. As described with regard to steps 1830-1840 of FIG. 18, reviewer inputs and user inputs are received, and content activity statistics are calculated and stored for a number of customer behaviors. In one embodiment, the statistics include the number of times that customers performed a particular behavior for each image. In that case, the ceiling refers to the maximum number of times that the particular activity was performed with relation to one content item. For instance, when considering all images in an archive, one image may have been viewed more times than all other images. The number of views of that image is the maximum number of times an image was viewed. Thus, that number of views is the ceiling value for the input category called “views.” Similarly, for the category of “downloading an image,” the ceiling is the number of times that a single image was downloaded, for the image that was downloaded the most times. Note that the ceiling value for the downloading user statistic is may also be referred to as “max downloads,” such as in Table S2 below.

A ceiling value can also be determined for review input categories. For example, when considering all images that have been given a rating by reviewers, one image may have been given the highest rating on a rating scale. The highest rating given may, or may not be the highest possible rating on the scale. For instance a rating scale may be 0 to 5 stars. However, for all images reviewed, the highest rating given by the reviewers may have only been 4 stars. No image was rated as 5 stars. In that case, the ceiling would be 4. In another embodiment, the ceiling may simply be set as the highest possible rating on the rating scale (e.g., 5 stars). For an input category that only has binary values (e.g., 0 for false and 1 for true), the ceiling value would be 1. In any case, the ceiling value of each category is declared to be the 100% value for the category.

Once the ceiling values are determined, each content item is evaluated, based in part on the ceiling values. Specifically, an adjustment value is calculated for each category of input. Each adjustment value is a proportion of the ceiling value. Accordingly, each adjustment value determines each input category's portion of the overall snappyness for a content item.

Accordingly, at step 1920 two reviewer adjustment values are calculated for each content item: a “reviewer rating adjustment” and an “editor's pick adjustment.”

For each content item, the reviewer rating adjustment is obtained by dividing the reviewer rating of that content item by the ceiling value. If the ceiling value is predefined as the highest value of the rating scale, the reviewer rating adjustment is simply a percentage of the rating scale. For example, a rating scale between 0 and 5 stars would mean that each rating unit was 20 percent of the total scale (i.e., the reviewer rating adjustment would be 0.2). The reviewer rating adjustment can later be multiplied by the predefined snappyness weight assigned to the reviewer rating input category. In another embodiment, the reviewer rating adjustment may be normalized to a 100 point scale. In the case of the 5-star rating scale, the number of stars given to an image may be multiplied by 20 to yield a review rating adjustment score. In that case, the review rating adjustment score may be 20, 40, 60, 80, or 100. This intermediate score can later be multiplied by a percentage that represents the snappyness weight assigned to the reviewer rating input category.

The editor's pick adjustment is defined as either 1 or 0 for picked or not picked. The editor's pick adjustment can later be multiplied by the predefined snappyness weight assigned to the editor's pick input category. In one embodiment, the editor's pick adjustment may be normalized to a 100-point scale. In that case, 100 points if the image was selected by the reviewer as an editor's pick, or 0 points if the image was not selected as an editor's pick. This intermediate score can later be multiplied by a percentage that represents the snappyness weight assigned to the editor's pick input category.

At step 1930 adjustments are computed for each of the five user activity input categories. For each input category, the adjustment for each content item is computed as the number of times a user activity was detected for that content item, divided by the ceiling value for that activity input category. In another embodiment, the resulting quotient can be multiplied by 100 to yield a value between 0 and 100. Again note that dividing by the ceiling value has the effect of normalizing the user activity frequency to a value between 0 and 1.

At step 1940, a temporal decay adjustment is computed. In one embodiment, temporal decay is a negative adjustment that accounts for lack of recent user activity. Temporal decay generally lowers the snappyness score of an image due to user inactivity with respect to the image. The number of days since the last user activity is used as an index into a table that determines the temporal decay adjustment, such as show in Table S1 bellow:

TABLE S1
Temporal Decay Adjustment Table

| Days since last user activity | Score |
|---|---|
| <30 | 0 |
| 30-59 | −20 |
| 60-89 | −40 |
| 90-119 | −60 |
| 120-179 | −80 |
| >=180 | −100 |

Here “last user activity” means that no user has subsequently performed any of the five user activities that are being taken into account for the snappyness computation. Note that in this embodiment, no penalty is assessed if there has been any user activity in the past 30 days; while, if there has been no activity in the past 180 days then the snappyness score is decreased by 100 points.

In Step 1950 snappyness is computed, taking into account the various input category adjustments (referred to as “a(i)”) that were computed in the preceding steps. A weight, “w(i),” is applied to each of the seven input category adjustments. If the input category adjustments were left as quotients, the weights may be points assigned to each input category. Conversely, if each input category adjustment was normalized to a scale of 100, the weights may be 0<w(i)<1. In that case, w(1)+w(2)+w(3)+w(4)+w(5)+w(6)+w(7)=100. The weights account for the significance of the particular input category. Snappyness is computed by adding the seven weighted adjustment factors and then adjusting for temporal decay. In one embodiment, if the resulting snappyness is a negative number, the snappiness is set to 0. An embodiment of snappyness can be stated as follows:

$$S = {\sum }_{i = 1 to 7} a ( i ) * w ( i ) + Temporal Decay$$

$$If S >= 0 , Snappyness = S ; if S < 0 , Snappyness = 0.$$

Table S2 below, summarizes the adjustments, and provides example weights, along with example scoring.

TABLE S2
Summary of Snappiness Computation

| Adjustment | Example Weight | Scoring |
|---|---|---|
| Reviewer | 15 | 0, 20, 40, 60, 80, |
| Rating | | 100 |
| Editor's | 15 | 0 or 100 |
| Pick | | |
| No. of times | 15 | # times down- |
| downloaded | | loaded * 100/max |
| | | downloads |
| No. of times | 15 | # times |
| favorited | | favorited * |
| | | 100/max favorited |
| No. of times | 15 | # times viewed * |
| viewed | | 100/max viewed |
| No. of times | 15 | # times tagged * |
| tagged | | 100/max tagged |
| No. of comments | 10 | # comments * |
| made | | 100/max comments |
| Temporal Decay | 0, −20, −40, −60, −80, −100 | Date of last |
| | | activity is index |
| | | into table. |

It can be appreciated by those skilled in the art that the use of snappyness is not restricted to digital images; it can be applied to any content, including inter alia music recordings, movies, speeches, courses, and graphics. Further, it can be appreciated by those skilled in the art that snappyness provides a single value (e.g., between 0 and 100) that reflects both reviewer input regarding content and user interest as determined by their activities (or lack of activities) regarding that content.

As discussed above, snappyness can be used for many purposes. For example, snappiness can be used to dynamically adjust prices. In one embodiment, the snappyness value could be multiplied by a maximum image price to obtain a new price, such as follows:

New price=(maximum price*snappyness)/100.

In one embodiment, snappyness can be used to order search results. For example, the snappyness value of an image can be used to determine the position of the image in the search result list such that an image that is snappier appears above an image that is less snappy. In one embodiment, snappyness can be used explicitly as a sort index. For example, if a search returns a list of images, the user can click on Snappyness in order to sort the list such that an image that is snappier appears above an image that is less snappy.

In one embodiment, snappyness can be used to select images to showcase on a web page. For example, a web page may be designed to display three “showcase” images. The three images with the highest snappyness values can then be used.

In one embodiment, snappyness can be used to provide guidance to a photographer as to whether to modify their recommended pricing. For example, if the user recommends or selects $5 as the price for an image, an embodiment of the inventive system could provide a message that informs the photographer what the median price is for images that have approximately the same snappiness value. In one embodiment, snappyness can be used to inform a photographer as to the popularity of their image. For example, snappyness can be interpreted as a measure of value and the system might display the snappyness value of an image to the photographer and provide additional information about what percentage of images are more or less snappy.

In another embodiment, the snappyness of all content supplied by a content provider may be summed to determine a content provider snappyness, which could be compared to other content providers. In a further embodiment, the snappyness of content in a group of content may be summed to determine a content type snappyness. This may enable users or content managers to determine which types of content receive more attention than other types of content. Similarly, the snappyness of content may be summed or otherwise evaluated according to each type of use to determine snappyness. These aggregations may also be fed back to affect content price adjustment.

Conversely, an input category may be the type of use. For example, an image may be given a higher snappyness score if it is used often for advertising products. Another input category may be availability of the content. For instance, an image that has limited availability (e.g., in a certain geographic location) may be given a higher snappyness score.

In another embodiment, snappyness can be used to group content. For instance, images that are tagged with a certain keyword may be grouped together if they have a snappyness above a certain threshold. Alternatively, all images that are tagged with a certain keyword may be ranked according to snappyness.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent is:

1. A method for determining a price adjustment for a content unit, comprising:
associating an intrinsic value factor with the content unit, wherein the intrinsic factor includes a suggested price;
associating an extrinsic value factor with the content unit, wherein the extrinsic factor includes a reviewer rating and an indication of content activity; and
determining a price adjustment for the content unit based on processing the intrinsic value factor and the extrinsic value factor.

2. The method of claim 1, further comprising receiving a customer selection in response to a display of the content unit along with the determined price.

3. The method of claim 2, wherein the display of the determined price is dynamically updated in response to at least one change to at least one of the intrinsic value factor or the extrinsic value factor.

4. The method of claim 2, further comprising arranging the display based on at least one of the extrinsic value factor or the intrinsic value factor.

5. The method of claim 2, further comprising providing the customer with a license to use the selected content unit.

6. The method of claim 1, further comprising displaying the price adjustment and receiving an instruction to change a price for licensing the content unit.

7. The method of claim 1, further comprising automatically determining a price for licensing the content unit based on the price adjustment.

8. The method of claim 1, further comprising associating at least one of a minimum price or a maximum price with the content unit such that determining the price adjustment is based in part on at least one of the minimum price or the maximum price.

9. The method of claim 1, further comprising indicating a predefined price category for the content unit based on the price adjustment.

10. The method of claim 1, further comprising automatically associating the content unit with a predefined price category based on the price adjustment.

11. The method of claim 1, wherein the reviewer rating indicates a value on a predefined scale.

12. The method of claim 1, wherein the content activity includes an indication of a number of views of the content unit, an indication of a number of downloads of the content unit, an indication of whether a tag is associated with the content unit, an indication of whether a user comment is associated with the content unit, and an indication of a number of times the content unit was selected as a favorite.

13. The method of claim 1, further comprising processing at least one of the intrinsic value factors and the extrinsic value factors, wherein the processing includes one or more of normalization, arithmetic computations, functional analysis, frequency, weighting, coalescing, aggregation, or statistics.

14. The method of claim 1, further comprising determining a snappyness score based on reviewer rating and the content activity.

15. A processor readable media storing machine instructions that cause a processor to perform the operations of claim 1.

16. An apparatus for determining a price adjustment for a content unit, comprising:
a processor;
a memory in communication with the processor and storing processor readable instructions that causes the processor to perform a plurality of operations, including:
associating an intrinsic value factor with the content unit, wherein the intrinsic factor includes a suggested price;
associating an extrinsic value factor with the content unit, wherein the extrinsic factor includes a reviewer rating and a content activity; and
determining a price adjustment for the content unit based on processing the intrinsic value factor and the extrinsic value factor.

17. The apparatus of claim 16, further comprising a communication interface in communication with the processor and communicating the price adjustment to a client.

18. A system for licensing a content unit, comprising:
a server that performs actions, including:
associating an intrinsic value factor with the content unit, wherein the intrinsic factor includes a suggested price;
associating an extrinsic value factor with the content unit, wherein the extrinsic factor includes a reviewer rating and a content activity; and
determining a price adjustment for the content unit based on processing the intrinsic value factor and the extrinsic value factor; and
a client in communication with the server and that performs actions, comprising:
displaying the content unit and a licensing price that is based on the price adjustment; and
receiving a request to license the content unit.

19. A method for determining a snappyness score for a content unit, comprising:
receiving a reviewer rating of the content unit;
receiving an indication of content activity based on at least one online behavior that involved the content unit;
applying a reviewer rating weight to the reviewer rating;
applying a content activity weight to the indication of content activity; and
calculating the snappyness score based on the reviewer rating, the indication of the content activity, the reviewer rating weight and the content activity weight.

20. The system of claim 19, further comprising determining a price adjustment for the content unit, based on the snappyness score.
